(19) United States
(12) Patent Application Publication
(10) Pub. No.: US 2001/0050829 A1
(43) Pub. Date: Dec. 13, 2001

(54) MAGNETIC RECORDING AND REPRODUCING SYSTEM INCLUDING A RING HEAD OF MATERIALS HAVING DIFFERENT SATURATION FLUX DENSITIES

(76) Inventors: OSAMU KITAKAMI, KITASOMA-GUN (JP); HIROSHI HIRANO, KITASOMA-GUN (JP)

Correspondence Address: BIRCH STEWART KOLASCH & BIRCH, PO BOX 747, FALLS CHURCH, VA, 22040-0747, US

(21) Appl. No.: 08/343,876

(22) Filed: Nov. 17, 1994

Related U.S. Application Data
(63) Continuation of application No. 07/910,564, filed on Jul. 8, 1992, now abandoned.

(30) Foreign Application Priority Data
Jul. 10, 1991 (JP) 3-195743

(51) Int. Cl. G11B 5/235

(52) U.S. Cl. 360/120

(57) ABSTRACT

In carrying out recording on a magnetic recording medium having substantially uniaxial oblique magnetic anisotropy to the surface of the medium, magnetic characteristics can be remarkably improved by running a ring head having a high saturation magnetic flux density material only on one side of gap portion in normal direction in respect to the magnetic recording medium with a gap edge of the high saturation magnetic flux density material side being ahead, thereby to carry out recording and/or reproducing.

### BACKGROUND OF THE INVENTION

The present invention relates to a magnetic recording and reproducing system. More particularly, it relates to a magnetic recording and reproducing system in which excellent magnetic characteristics can be realized in recording media having oblique magnetic anisotropy.

With the growth of information-oriented society, mass and high density recording has been strongly demanded in the field of recording technique. Under such circumstances, rapid technical improvement has been hastened in the fields of optical recording and semiconductor memory devices. This is the same in the field of magnetic recording and recently, attempt has been made to more strongly develop the high density recording by employing thin film type recording media in place of the conventional magnetic powder coated type recording media and such recording has already partially been put to practical use. Especially in the field of image recording, rapid progress in technique of formation of finer images and digital images is expected and development of higher density recording technique is earnestly demanded for magnetic recording tape.

Recently, oblique magnetic anisotropy thin films prepared by oblique vapor deposition of Co-Ni alloy on a base film (called “Metal-Evaporated tape”, which can be abbreviated to “ME tape”) have been developed as high-band 8 mm VTR tapes and have already been commercialized. This material is excellent in high-density recording performance and is one of the materials which show the most excellent characteristics in respect of performance among a large number of recording medium materials which have been developed until now.

Normally, so-called Metal-In-Gap (abbreviated to “MIG”) type ring heads in which high saturation magnetic flux density sendust and Co-based amorphous sputtered film are provided at both ends of gap portion are used as recording and reproducing magnetic heads for ME tapes. However, even if such magnetic head and the obliquely vapor deposited tape (ME tape) are used in combination, it has been difficult to realize such recording characteristics as can sufficiently catch up the demand for production of finer and digital images in the future.

### SUMMARY OF THE INVENTION

The object of the first invention is to provide a magnetic recording and reproducing system which can exhibit excellent recording characteristics in recording media having oblique magnetic anisotropy and which is free from the defects seen in the conventional techniques.

For attaining the above object, the first invention provides a recording and reproducing system according to which in carrying out recording in a magnetic recording medium having a substantially uniaxial oblique magnetic anisotropy in respect to the surface of the film, a ring head provided with a material having high saturation magnetic flux density only on one side of gap portion is run in normal direction in respect to the recording medium with the gap edge of the high saturation flux density material side being ahead, namely, a leading edge.

The object of the present invention is to provide a magnetic recording medium excellent in high-density recording performance and free from the problem of insufficient SIN ratio in high recording density area in the conventional techniques.

According to the second embodiment, in a magnetic recording medium comprising non-magnetic substrate 16 and low coercivity underlayer 17 and high coercivity recording layer 18 provided on the substrate as shown in accompanying FIG. 5, saturation magnetization of the low coercivity underlayer is smaller than that of the high coercivity recording layer and its value is within the range of 50-300 G. A non-magnetic underlayer may be provided optionally between the nonmagnetic substrate 16 and the low coercivity underlayer 17.

By employing the above construction, S/N ratio in a wide recording density region of the recording medium is improved, but the effect of the second invention can further be increased by imparting the following characteristics to the low coercivity underlayer 17. That is, coercive forces in the direction normal to the film surface and in the in-plane direction measured when an external magnetic field of 50 Oe or less is applied to the high coercivity recording layer and the low coercive force undercoat layer after both of them have been demagnetized are 10 Oe or less and furthermore, magnetic permeability of the low coercivity underlayer measured at demagnetized state is 10 Oe or higher.

### BRIEF DESCRIPTION OF THE DRAWINGS

FIG. 1A and FIG. 1B are schematic views which show the magnetic recording and reproducing system of the present invention.

FIG. 2A is a schematic sectional view of one id example of a batch type vacuum deposition apparatus used for production of a magnetic recording medium suitable for the magnetic and recording system of the present invention.

FIG. 2B is a schematic sectional view of one example of a continuous type vacuum deposition apparatus used for production of a magnetic recording medium suitable for the magnetic and recording system of the present invention.

FIG. 3 is a schematic sectional view which shows the state of acicular magnetic material particles being oriented in the direction oblique to the surface of the substrate.

FIG. 4 schematically shows the direction of major axis of magnetic anisotropy of Co-Ni-O film prepared in Example 1.

FIG. 5 is a schematic sectional view which shows one example of structure of the magnetic recording medium according to the present invention.

FIG. 6 schematically explains the role of the low coercivity underlayer during recording process.

FIG. 7 schematically explains the role of the low coercivity underlayer during reproducing process.

FIG. 8 is a schematic view of a vacuum deposition apparatus used in Example 6.

In the above Figures, the reference numbers denote the following.

1: The low saturation magnetic flux density material side of MIG head

2: The high saturation magnetic flux density material side of IG head

3: Recording film with oblique magnetic anisotropy against film surface

4: Direction of principal axis of magnetic anisotropy

5: Substrate

7: Electron gun

8: Variable leak valve

9: Exhaust port

10: Roll

11: Can roll

13: Acicular magnetic particles

14: Binder

15: Substrate

16: Non-magnetic substrate

17: Low coercivity underlayer

18: High coercivity recording layer

19: Exhaust port

20: Roll

21: PET film substrate

22: Water cooling can drum

23: Mask

24: Gas introduction port

25: Needle valve

26: Co evaporation source

27: Ni-Cu evaporation source

28: Electron gun

### DETAILED DESCRIPTION OF THE INVENTION

The first invention will be explained.

As aforementioned, according to the magnetic recording and reproducing system of the first invention, excellent S/N ratio and magnetic characteristics can be obtained by running a ring head provided with a high saturation magnetic flux density material only on one side of gap portion (hereinafter referred to as “one-side MIG head”) in the normal direction in respect to a recording medium having oblique magnetic anisotropy with the gap edge provided with the high saturation magnetic flux density material being the leading edge.

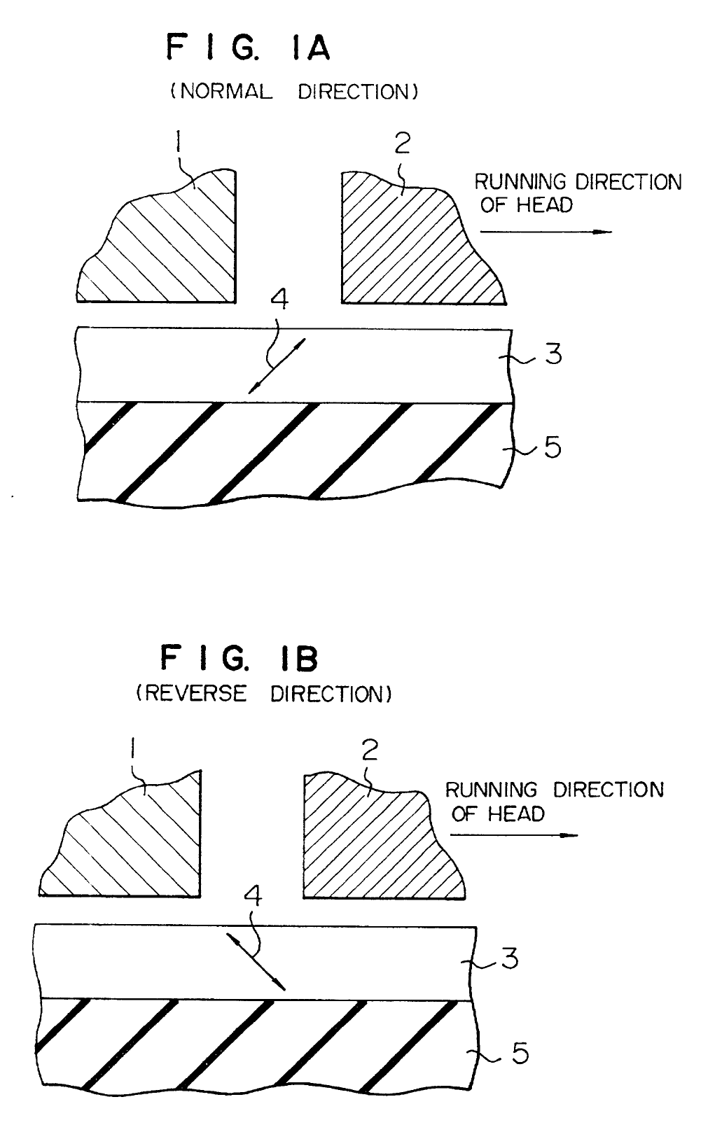

The mechanism has not yet been exactly clarified that the recording characteristics can be improved when one-side MIG head is run in the normal direction with respect to the recording medium having oblique magnetic anisotropy with the gap edge of the one-side MIG head provided with a high saturation magnetic flux density material being ahead. However, it can be conjectured that as shown in FIG. 1A (normal direction recording), when recording and reproducing are carried out on recording layer 3 by high saturation magnetic flux density material edge 2, since magnetic field generated from low saturation magnetic flux density material edge 1 is weak and besides, vector magnetic field close to the hard axis of magnetization of the magnetic layer is generated, the previously written information is hardly demagnetized and remains as it is and recorded magnetization which remains after passing of the head increases. On the other hand, as shown in FIG. 1B (Reverse direction recording), when a one-side MIG head is run in the reverse direction in respect to the recording medium having oblique magnetic anisotropy with the gap edge of high saturation magnetic flux density material being ahead, the recording layer 3 is hard to be magnetized by the leading edge 2, because the field direction from edge 2 is near in the hard axis of magnetization of the layer 3. Thereafter, when the rear edge 1 comprising a low saturation magnetic flux density material passes, only weak recorded magnetization remains because magnetic field generated from the rear edge is weak.

In order to obtain the desired effect of the first invention, it is necessary that difference in saturation magnetic flux density of the low saturation magnetic flux density material side and that of the high saturation magnetic flux density material side of the ring head is at least 1.2 time, preferably at least 1.4 time as practical level. It is desirable that the difference in saturation density be as large as possible, but the effect is saturated at about 10000 G and hence, the larger difference is unnecessary.

The materials constituting the one-side MIG head used in the first invention are, for example, Mn-Zn ferrite, Ni-Zn ferrite and amorphous alloys rich in non-magnetic elements as materials for low saturation magnetic flux density side. On the other hand, as the materials for high saturation magnetic flux density side, mention may be made of Permalloy, sendust, Fe-Si, Fe, Fe-Co, Fe-C or Co based amorphous alloys and nitride multilayer films of these alloys. Method for making the one-side MIG head of the present invention using these materials is well known to one skilled in the art and there will be no need to explain it here.

Furthermore, in order to realize superior recording characteristics by subjecting the above-mentioned recording film having oblique magnetic anisotropy to recording in normal direction by the one-side MIG head, it is preferred that the substantial direction of principal axis of oblique magnetic anisotropy rises by 10-80° from the surface of the film. If the rising angle is less than 10°, the merit of perpendicular magnetic recording method which is theoretically excellent in high density recording performance cannot be utilized and sufficiently high density recording performance cannot be obtained. On the other hand, if the rising angle is more than 80°, recording and reproducing characteristics nearly the same as those obtained by so-called both-side MIG head provided with high saturation magnetic flux density material on both sides are obtained and in any way, saturation recording and overwrite becomes difficult and no conspicuous improvement of recording characteristics can be obtained.

Recording and reproducing can be carried out with one head by combining the oblique magnetic anisotropy recording film 3 with one-side MIG head 1 keeping the relative positional relation as shown in FIG. 1A. As alternative method, when only recording is carried out by the arrangement as shown in FIG. 1A and reproducing of signal is carried out by other magnetic head, for example, magnetoresistance effect type head (MR head), recording and regenerating characteristics can further be improved.

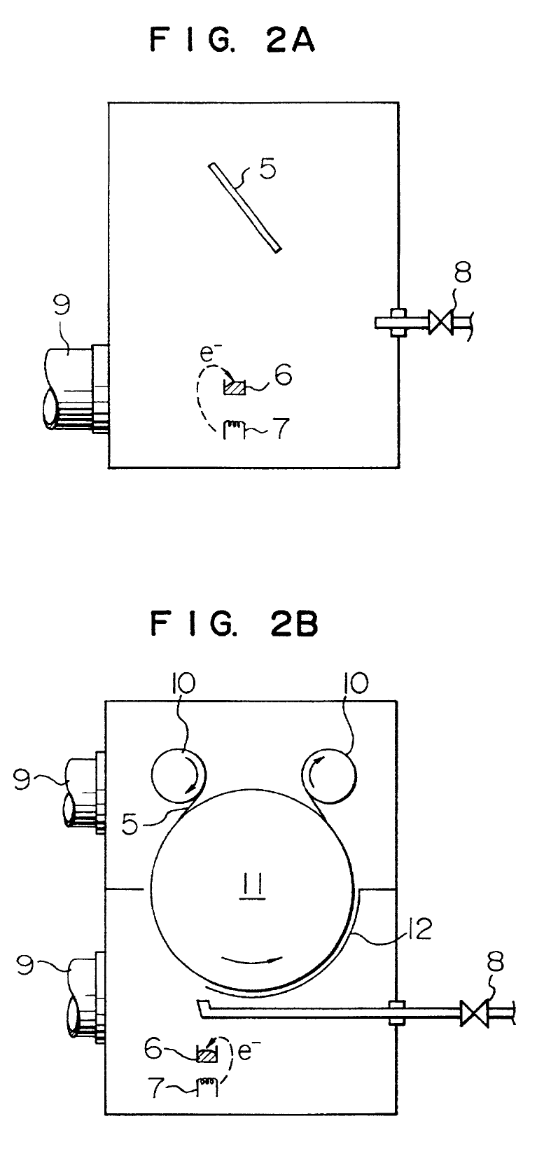

The recording medium can be a recording film having obliquely magnetic anisotropy substantially against the film plane and such film can be formed by depositing Fe, Co, Ni or an alloy mainly composed of them obliquely onto the surface of substrate. One example of apparatus for production of the film is shown in FIGS. 2A and 2B.

FIG. 2A is a schematic view of a batch type vapor deposition apparatus for oblique evaporation, in which the vapor evaporation source 6 is deposited obliquely substrate surface 5. FIG. 2B is a schematic view of a winding-up type vapor deposition apparatus for producing a long tape in which oblique evaporation is performed by adjusting the position of mask 12. Examples of vapor deposition apparatuses are shown here, but other thin film forming methods such as ion plating and sputtering can also produce an oblique magnetic anisotropy film by obliquely directing metal atoms toward a substrate. Furthermore, for improvement of magnetic characteristics and mechanical characteristics of the film, the film formation may be carried out while introducing oxygen, nitrogen, an inert gas or a mixed gas thereof into the vacuum chamber.

The obliquely magnetic anisotropy recording At film which can be utilized in the first invention is not limited to the metallic thin film mentioned above, but may be a medium prepared by coating a dispersion of magnetic fine particles in a binder (so-called coating type medium). As the magnetic fine particles, mention may be made of acicular particles such as γ-Fe₂O₃, Fe₃O₄, Co-deposited γ-Fe₂O₃, Fe and Fe-Co alloys and fine particles such as Ba ferrite.

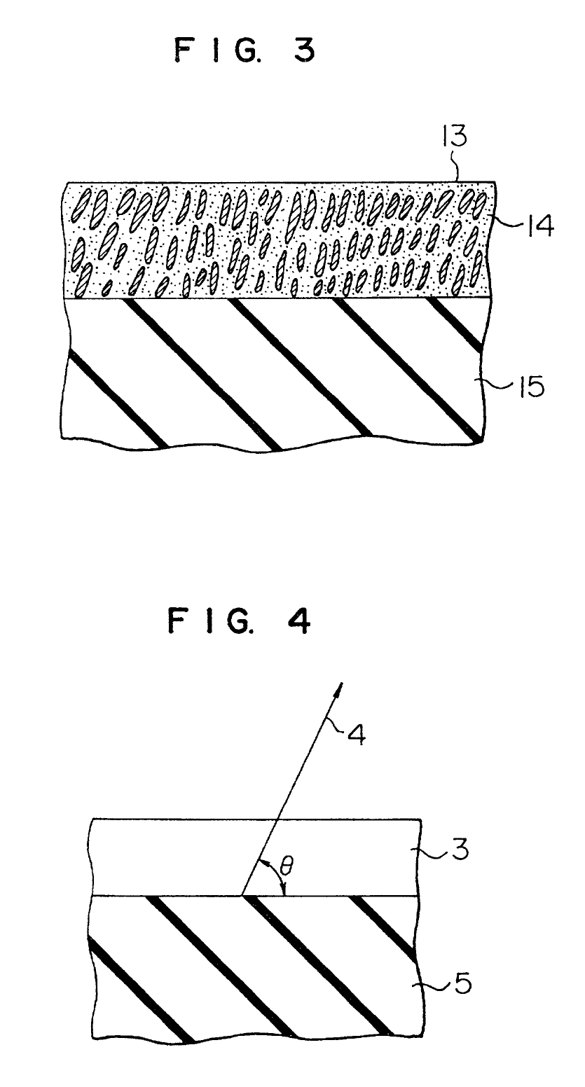

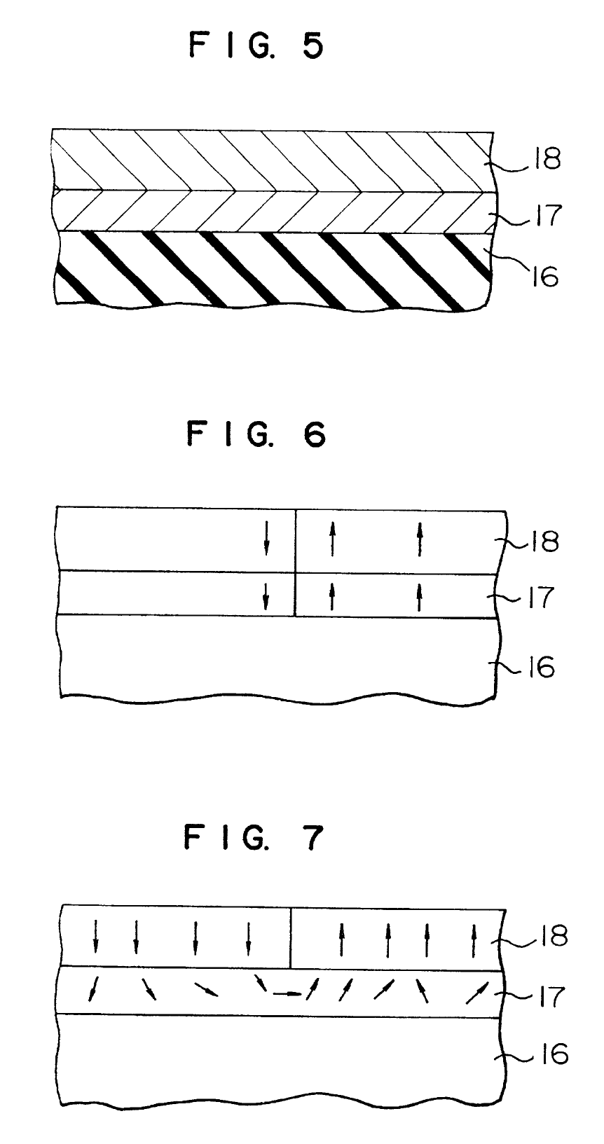

In the case of the former acicular particles, its major magnetic anisotropy is due to the shape anisotropy and in order to impart oblique magnetic anisotropy using such materials, the acicular particles can be oriented substantially obliquely to the substrate surface as shown in FIG. 3. In this case, the particles may not necessarily be uniformly obliquely oriented in respect to the direction of film thickness, but if obliquely magnetic anisotropy is exhibited on the average of the whole film, the effect of the first invention is realized.

In the case of the latter platy particles such as Ba ferrite, since the magnetic anisotropy is mostly due to its high magneto crystalline anisotropy, an oblique magnetic anisotropy film can be formed by suitably adjusting the orientation direction of the crystal axis.

Next, the second invention will be explained.

In the second invention, irrespective of perpendicular recording media or longitudinal recording media, S/N ratio in high recording density area is experimentally much improved by employing the above-mentioned construction. It is considered that this is because the structure of the recording media of the present invention complies with the guiding principle for improving the S/N ratio. Details thereof will be mentioned below. Since similar mechanism is considered for both the perpendicular recording and the longitudinal recording, explanation will be made here on the perpendicular recording, namely, the case of recording magnetic layer 18 being a perpendicular magnetic anisotropy film. The same interpretation can be made on oblique magnetic anisotropy film which is intermediate between the perpendicular and longitudinal magnetic anisotropy film.

First, consideration will be made from the side of recording process on the role of the low saturation magnetization and low coercivity underlayer 17 using FIG. 6. When a magnetic head carries out recording on high coercivity recording layer 18, the low coercivity underlayer 17 is more easily magnetized. Regarding degree of the easiness of magnetization, magnetization state in accordance with the distribution of magnetic field of the head is readily realized as the magnetic property of the underlayer 17 becomes softer and the saturation magnetization decreases. Like this, when the low coercivity underlayer 17 is magnetized, the recording layer 18 is also magnetized owing to exchange coupling between the underlayer and the high coercivity recording layer 18 provided on the underlayer 17. Therefore, from the point of recording process, presence of such low coercivity underlayer has the role to markedly reduce the magnetic field of the head needed to substrate the high coercivity recording layer 18. Considering this fact from practical aspect, this means that the magnetic head can be driven with a low recording current less than magnetic saturation of the head and there is the great merit that a steep spatial distribution of magnetic field of head, namely, sharp recording transmissions can be attained. From the viewpoint of recording process mentioned above, saturation magnetization of the low coercivity underlayer has an optimum value and if this is too low, the exchange interaction between both the layers is weak and if it is too high, magnetization state in accordance with the distribution of magnetic field of the head cannot be realized due to the large demagnetizing field generated in the underlayer.

Next, features of the magnetic recording media of the present invention will be explained from the side of producing process using FIG. 7. After magnetic head has performed recording and passed away, the magnetization in the low coercivity underlayer is likely to reach random distribution, although it is influenced by exchange interaction with the high coercivity recording layer. However, since strong leakage magnetic field gradient appears in the vicinity of transition of magnetization, only the low coercivity underlayer in the vicinity of the transition of magnetization is strongly magnetized and a horse-shoe magnetization mode is formed between high coercivity recording layer and low coercivity underlayer as shown in FIG. 7. As a result, free magnetic poles on the back side of the high coercivity recording layer are diminished and demagnetizing field which acts on recorded magnetization decreases and as a result, recording magnetization in the vicinity of magnetization transition area is stabilized. It is considered that in this way, reproducing output is increased, but when saturation magnetization of the low coercivity underlayer is too low, formation of horse-shoe magnetization mode is insufficient and when it is too high, noise level becomes very high.

Mechanism of the effect of the present invention has been studied above from the aspects of recording and reproducing process. As mentioned above, according to experiments conducted by the inventors, the best S/N ratio can be realized in the high recording density region when saturation magnetization of the low coercive force undercoat layer is made smaller than that of the high coercivity recording layer and the value of the former is 50-300 G. Furthermore, as can be expected from the above-mentioned mechanism, the low coercive force undercoat layer preferably has a soft magnetic properties, but evaluation of magnetic characteristics of individual layer in the laminate state as of the second embodiment is difficult and there has been no effective measuring method. For avoiding such difficulty, each layer has been formed individually and magnetic characteristics of each layer have been evaluated. However, it is clear that such evaluation method is not correct. Firstly, when a high coercivity recording layer is formed on low coercivity underlayer 17, magnetic characteristics greatly change due to changes in thermal residual stress and in internal stress of the film during film deposition process. Secondly, atomic diffusion occurs at the interface of the low coercivity underlayer and the high coercive force recording layer and magnetic characteristics also change due to a change of composition. Thirdly, owing to magnetic coupling between both layers, magnetic behavior of the low coercivity underlayer greatly differs in the state of single layer and in the laminate state.

Thus, it is not correct to discuss the magnetic behavior in laminate state from magnetic characteristics in the state of single layer and misunderstanding often occurs. In order to solve these problems, the inventors have conceived a new evaluation method of magnetic characteristics of low coercivity underlayer in laminate state. This is a means to evaluate magnetic characteristics of the low coercivity underlayer in a weak magnetic field in which the high coercivity recording layer is hardly magnetized, after demagnetization of the above-mentioned laminate film. Previously, it is mentioned that the low coercivity underlayer of the laminate type magnetic recording media of the second invention must have soft magnetic properties, but it has been confirmed according to the above evaluation method that especially excellent recording and reproducing characteristics can be realized when the low coercivity underlayer satisfies the following two requirements. The first is that the coercive forces in the direction normal to the film surface and in the in-plane direction to the film surface when an external magnetic field of 50 Oe or less is applied after demagnetization of both the high coercivity recording layer and the low coercivity underlayer are 10 Oe or less. The second is that magnetic permeability of the low coercivity underlayer measured after demagnetization of both the high coercive force recording layer and the low coercivity underlayer is 10 or higher. These two requirements are properties needed for the low coercivity underlayer in addition to setting the saturation magnetization at low level in order to realize excellent recording characteristics.

Any materials which satisfy the above requirements can be used as materials of the low coercivity underlayer in the magnetic recording media of the present invention. Examples are crystalline and amorphous alloys containing Fe, Co or Ni, oxide materials such as Mn-Zn ferrites and nitride materials. Materials of the high coercive force recording layer include, for example, alloys and oxide materials mainly composed of Fe, Co or Ni. Examples of Co-based materials are Co-Ni, Co-Cr, Co-Pt, Co-Ta, Co-O, Co-Fe-O, Co-Ni-O, Co-Ni-Cr, Co-Ni-Pt, Co-Ni-Ta, Co-Cr-Ta and Co-Cr-Pt.

When in-plane magnetic anisotropy or perpendicular magnetic anisotropy of the high coercive force recording layer is especially emphasized, a non-magnetic undercoat layer comprising Cr-based alloys or Ti or Ge may be provided between the low coercive force undercoat layer 17 and substrate 16.

Production method per se of the magnetic recording media of the second invention is not limitative. The non-magnetic undercoat layer, the low coercive force undercoat layer and the high coercive force recording layer in the magnetic recording media of the present invention can all be produced on a substrate, for example, by vapor deposition methods such as sputtering method and vacuum deposition method, which are known to one skilled in the art. Alternatively, the non-magnetic undercoat layer can also be formed by pulse plating method.

The non-magnetic substrates used in the magnetic recording media of the second invention include, for example, polymer films such as polyimide and polyethylene terephthalate, glasses, ceramics, anodized aluminum, metallic sheets such as brass, Si single crystal sheets and Si single crystal sheets subjected to surface thermal oxidation treatment in addition to aluminum sheets.

The magnetic recording media of the second invention include, for example, magnetic tapes and magnetic disks having synthetic resin films such as polyester films and polyimide films as a substrate, magnetic disks and magnetic drums having discs or drums comprising synthetic resin films, aluminum sheets or glass sheets as a substrate, and those which have various shapes of the structure capable of contact-sliding with magnetic head.

### DESCRIPTION OF THE PREFERRED EMBODIMENTS

The first invention of the present application will be illustrated by the following examples.

### EXAMPLE 1

Vapor deposition of Co-Ni alloy 6 on a PET (polyethylene terephthalate) film of 9 μm thick as substrate 5 was carried out using a winding-up type vapor deposition apparatus shown in FIG. 2B. Improvement of magnetic characteristics and mechanical characteristics was contemplated by introducing oxygen gas from gas introduction port 8 during vapor deposition. The principal axis of magnetic anisotropy of the resulting Co-Ni-O film rose by about 35° on the average from the surface of the film. The direction θ of this principal axis of the anisotropy was obtained from a torque curve corrected by demagnetizing field. A ½ inch tape was cut out from the thus obtained oblique magnetic anisotropy Co-Ni-O film and recording characteristics thereof were measured by a drum tester. The magnetic heads used for the tests were ferrite head, MIG head and one-side MIG head as shown in Table 1. The high saturation magnetic flux density material used in MIG head and one-side MIG head was Co-Nb-Zr amorphous material having a saturation magnetic flux density of 9300 gausses. On the other hand, the low saturation magnetic flux density material was Mn-Zn ferrite having a saturation magnetic flux density of 5500 gausses.

TABLE 1

| | | Length of | Width of |
|---|---|---|---|
| Head No. | Structure | gap | truck |
| A | Ferrite head | 0.19 μm | 26 μm |
| B | MIG head | 0.18 μm | 26 μm |
| C | One-side MIG head | 0.19 μm | 26 μm |

Results of evaluation are shown in Table 2. Results of measurement of CN ratio are all expressed using as a standard the CN ratio which is obtained when recording is carried out by the ferrite head (head A) in normal direction and which is assumed to be 0 dB. In Table 2, head C(L) and head C(T) indicate the cases when the one-side MIG head was run with the gap edge of the high saturation magnetic flux density side being ahead and behind, respectively.

TABLE 2

CN ratio (dB)

| | Running | Recording | |
|---|---|---|---|
| | direction | density | |
| Head | of head | 10 kFCl | 100 kFCl |
| A | Normal direction | 0 | 0 |
| B | ″ | +0.6 | +3.5 |
| C | Reverse direction | −0.1 | −1.7 |
| C(L) | Normal direction | +2.7 | +6.4 |
| C(L) | Reverse direction | −0.5 | −2.3 |
| C(L) | Normal direction | +0.5 | +1.6 |

### EXAMPLE 2

Three kinds of recording layers were formed on polyimide film substrates of 10 μm thick by vacuum evaporation method. Constructions thereof and inclination θ of the principal axis of magnetic anisotropy are summarized in the following Table 3. In Table 3, only medium a was prepared under the condition of oblique vapor deposition and others were prepared under the condition of vertical vapor deposition.

TABLE 3

| | | | Inclination of |
|---|---|---|---|
| | | | major axis of |
| | | | magnetic |
| | | | anisotropy |
| Sample | Recording layer | Undercoat layer | θ (° C.) |
| Medium a | 0.2 μm thick Co—Cr | — | 65 |
| | layer | | |
| Medium b | 0.2 μm thick Co—Cr | 0.03 μm thick | 90 |
| | layer | Ti layer | |
| Medium c | 0.2 μm thick Co—Cr | 0.10 μm thick | 0 |
| | layer | Cr layer | |

Recording characteristics of the above media were evaluated. The evaluation was conducted in the same manner as in Example 1. However, recording was carried out in normal running direction using one-side MIG head (head C) as a magnetic head. In all cases, the head was run so that the gap edge of the high saturation magnetic flux density side was ahead. Results of evaluation are summarized in Table 4. The CN ratio in the table is expressed using the CN ratio of medium a as a standard.

TABLE 4

| | CN ratio at | CN ratio at |
|---|---|---|
| Medium | 10 kFCI | 100 kFCI |
| a | 0 dB | 0 dB |
| b | −4.7 dB | −3.8 dB |
| c | +0.2 dB | −10.4 dB |

### EXAMPLE 3

The following magnetic coating compositions 1 and 2 were respectively well mixed and dispersed in a ball mill to prepare magnetic coating materials. Each of them was coated at a dry thickness of 0.7 μm on both sides of a polyethylene terephthalate (PET) base film of 62 μm thick, dried and then calendered to form magnetic layers.

Parts by weight

Magnetic coating composition 1

| | |
|---|---|
| α-Fe (Hc: 16500 Oe, saturation magnetization: | 100 |
| 135 emu/g, average major axis diameter: | |
| 0.25 μm, average axial ratio: 8) | |
| Vinyl chloride-vinyl acetate-vinyl | 14.1 |
| alcohol copolymer | |
| Urethane resin | 8.5 |
| Trifunctional isocyanate compound | 5.6 |
| Aluminum oxide powder (average particle | 20 |
| size: 0.43 μm) | |
| Carbon black | 2 |
| Oleyl oleate | 7 |
| Cyclohexanone | 150 |
| Toluene | 150 |

Magnetic coating composition 2

| | |
|---|---|
| Barium ferrite | 100 |
| (Hc: 530 Oe, saturation magnetization: | |
| 57 emu/g, average particle size: 0.04) | |
| Vinyl chloride-vinyl acetate-vinyl | 11.0 |
| alcohol copolymer | |
| Urethane resin | 6.6 |
| Trifunctional isocyanate compound | 4.4 |
| Aluminum oxide powder (average particle | 15 |
| size: 0.43 μm) | |
| Carbon black | 2 |
| Oleyl oleate | 7 |
| Cyclohexanone | 150 |
| Toluene | 150 |

Direction of orientation of particles was changed by applying external magnetic field to the coating layer before dried. The direction of the principal axis of oblique magnetic anisotropy of the coating layer was measured in the same manner as in Example 1 by a torque meter. Results of measurement of recording characteristics are shown in Tables 5 and 6. The CN ratio in the tables is expressed using as a standard the value which is obtained in the case of combination of MIG head (head B) with the medium of θ=0 and which is assumed to be 0 dB.

TABLE 5
Composition 1

| | Direction of | |
|---|---|---|
| | major axis of | |
| | magnetic anisotropy | CN ratio at |
| Head | θ degrees | 100 kFCI |
| B | 0 | 0 dB |
| | 15 | +0.5 dB |
| | 60 | +0.2 dB |
| C(L) | 0 | +0.1 dB |
| | 15 | +4.3 dB |
| | 60 | +2.8 dB |
| C(T) | 0 | −0.1 dB |
| | 15 | +0.1 dB |
| | 60 | −0.3 dB |

TABLE 6
Composition 2

| | Direction of | |
|---|---|---|
| | major axis of | |
| | magnetic anisotropy | CN ratio at |
| Head | θ degrees | 100 kFCI |
| B | 0 | 0 dB |
| | 10 | +0.3 dB |
| | 60 | +0.3 dB |
| | 90 | −0.5 dB |
| C(L) | 0 | +0.5 dB |
| | 10 | +3.4 dB |
| | 60 | +5.6 dB |
| | 90 | −0.6 dB |
| C(T) | 0 | −0.1 dB |
| | 10 | −0.1 dB |
| | 60 | −0.2 dB |
| | 90 | −0.3 dB |

As explained above, when recording is carried out using a magnetic recording medium having a uniaxial oblique magnetic anisotropy in respect to the surface of the film, recording characteristics can be markedly improved by running a one-side MIG head in normal direction to the recording medium with the edge of high saturation magnetic flux density material side being a leading edge.

Next, the second embodiment will be explained in detail by the following examples.

### EXAMPLE 4

An amorphous Co-Zr undercoat layer of 0.06 μm thick was formed on a glass disc substrate of 2.5 inches under heating at 120° C. and on this layer were formed a Co-20 wt % Cr perpendicular magnetic anisotropy film (saturation magnetization Ms₁=290 G) of 0.05 μm thick and a carbon film of 100 Å thick by sputtering. With reference to the Co-Zr film, a Zr chip was placed on a Co target and composition, namely, saturation magnetization of the Co-zr film was changed by changing the area of Co target which was covered by the Zr chip. Heat treatment at 25-250° C. was carried out in a rotating magnetic field to change magnetic characteristics of the Co-Zr undercoat layer. The heat treatment at this temperature caused no great change in magnetic properties of the Co-Zr undercoat layer. For evaluation of magnetic characteristics of the Co-Zr undercoat layer, an initial magnetization curve was drawn after the sample in laminated state was subjected to alternating current demagnetization and magnetic permeability μi was determined from inclination of the curve at zero magnetic field. For evaluation of coercive force Hc₂ of the undercoat layer, the coercive force was determined by applying an external magnetic field of 50 Oe to the sample in demagnetized state to draw a hysteresis curve. Recording was carried out on the resulting disc by a thin film type ring head with a gap length of 0.26 μm and reproduction was carried out by a magnetroresistance effect type head (MR head) of 0.08 μm in film thickness. Results of measurements are shown in Table 7. In the table, the S/N ratio is a value at a recording density of 100 kFCI.

TABLE 7

| | Co—Cr film | Co—Zr film | Co—Zr film | Co—Zr film | S/N ratio |
|---|---|---|---|---|---|
| | Saturation | Saturation | Magnetic | Coercive | (ratio to |
| | magnetization | magnetization | permeability | force | single layer film) |
| Sample | Ms₁(G) | Ms₂(G) | μ₁ | Hc₂(Oe) | dB |
| 1 | 290 | — | — | — | 0 |
| 2 | 290 | 800 | 950 | 2.4 | −6.2 |
| 3 | 290 | 430 | 390 | 3.0 | −3.7 |
| 4 | 290 | 270 | 280 | 0.8 | +3.3 |
| 5 | 290 | 110 | 210 | 1.1 | +5.8 |
| 6 | 290 | 70 | 80 | 0.3 | +2.7 |
| 7 | 290 | 40 | 30 | 0.3 | 0 |
| 8 | 290 | 110 | 6 | 13 | 0 |

### EXAMPLE 5

A Cr undercoat layer of 0.35 μm thick, a Ni-Cr alloy undercoat layer of 0.009 μm thick, a Co-Cr-Ta recording magnetic layer (saturation magnetization Ms₁=320 G) of 0.045 μm thick and a carbon film of 130 Å thick were formed on a glass disc substrate of 2.5 inches under heating at 150° C. by sputtering. With reference to the Ni-Cr film, a Cr chip was placed on a Ni target and composition, namely, saturation magnetization of the Ni-Cr film was changed by changing the area of the Ni target which was covered by the Cr chip. In the same manner as in Example 4, heat treatment at 25-250° C. was carried out in a magnetic field to change magnetic characteristics of the Ni-Cr layer. Magnetic characteristics and recording and regenerating characteristics were evaluated in the same manner as in Example 4 and the results are shown in Table 8.

TABLE 8

| | Co—Cr—Ta film | Ni—Cr film | Ni—Cr film | Ni—Cr film | S/N ratio |
|---|---|---|---|---|---|
| | Saturation | Saturation | Magnetic | Coercive | (ratio to |
| | magnetization | magnetization | permeability | force | single layer film) |
| Sample | Ms₁(G) | Ms₂(G) | μ₁ | Hc₂(Oe) | dB |
| 9 | 320 | — | — | — | 0 |
| 10 | 320 | 400 | 1300 | 1.5 | −2.6 |
| 11 | 320 | 270 | 860 | 0.9 | +2.3 |
| 12 | 320 | 110 | 630 | 0.8 | +3.9 |
| 13 | 320 | 30 | 80 | 2.3 | 0 |
| 14 | 320 | 110 | 8 | 9.0 | +0.5 |

### EXAMPLE 6

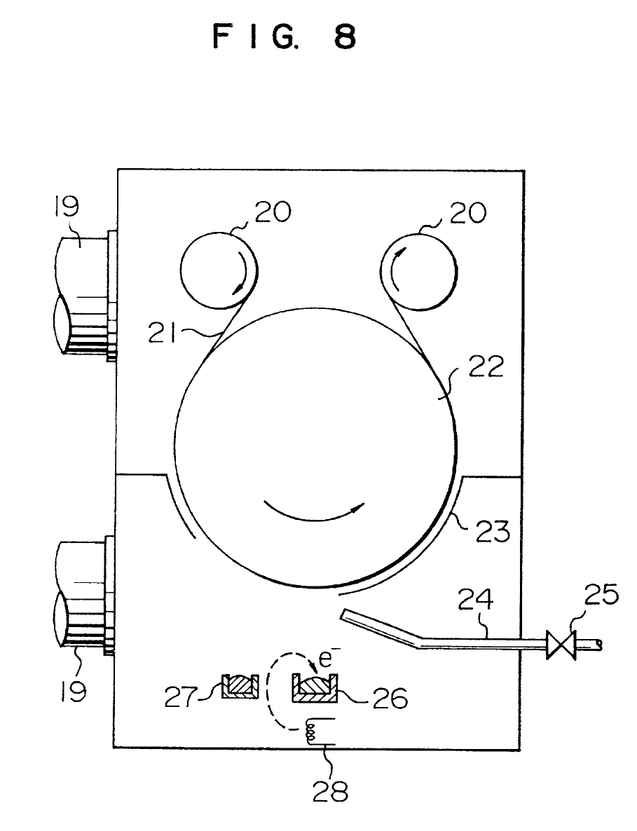

Using a winding-up type vacuum evaporation apparatus as shown in FIG. 8, a low coercive force Ni-Cu undercoat layer and a high coercive force Co-O recording magnetic film were evaporated on a PET (polyethylene terephthalate) film substrate 21 of 9.2 μm thick. The production process will be explained below. Degree of vacuum of lower than 5×10⁻⁶ Torr was attained in a vacuum chamber through exhaust ports 19 and then, film substrate 21 was delivered by rolls 20 and run along water cooling can drum 22, where an Ni-Cu undercoat film of 0.012 μm thick was deposited on the substrate from Ni-Cu evaporation source heated by electron beam and this film-deposited substrate was wound up on roll 20. Then, unwinding operation was carried out and Co-O film of 0.21 μm thick was deposited on the Ni-Cu undercoat film from Co evaporation source 26 while introducing oxygen gas into the vacuum chamber from gas introduction port 24. The resulting Co-O/Ni-Cu laminate film was subjected to alternating current demagnetization and an initial magnetization curve was drawn and magnetic permeability μi was determined from inclination of the curve at around zero magnetic field. For evaluation of coercive force Hc₂ of the undercoat layer, the coercive force was measured by applying an external magnetic field of 30 Oe to the sample in demagnetized state. For recording and reproducing characteristics, a sample in the form of a tape of ½ inch wide was cut out, and both recording and reproducing were performed by a CoNbZr amorphous ferrite composite MIG (metal-in-gap) type ring head with a gap length of 0.17 μm. The results are shown in Table 9.

TABLE 9

| | Co—O film | Ni—Cu film | Ni—Cu film | Ni—Cu film | S/N ratio |
|---|---|---|---|---|---|
| | Saturation | Saturation | Magnetic | Coercive | (ratio to |
| | magnetization | magnetization | permeability | force | single layer film) |
| Sample | Ms₁(G) | Ms₂(G) | μ₁ | Hc₂(Oe) | dB |
| 15 | 910 | — | — | — | 0 |
| 16 | 910 | 400 | 960 | 3.2 | +2.1 |
| 17 | 910 | 250 | 640 | 1.7 | +4.9 |

As explained above, according to the second invention, S/N ratio in high density recording area in a laminate film comprising a low coercive force undercoat layer and a high coercive force recording layer is improved when saturation magnetization of the former is smaller than that of the latter and is 50-300 G.

What is claimed is:

1. A magnetic recording and reproducing system, wherein in carrying out recording on a magnetic recording medium having substantially uniaxial oblique magnetic anisotropy to the surface of the medium, a ring head having a high saturation magnetic flux density material only on one side of gap portion is run in normal direction in respect to the magnetic recording medium with a gap edge of the high saturation magnetic flux density material side being ahead, thereby to carry out recording and/or reproducing.

2. A magnetic recording and reproducing system according to claim 1, wherein the gap edge of high saturation magnetic flux density material side has saturation magnetic flux density of at least 1.2 time that of another gap edge.

3. A magnetic recording and regenerating system according to claim 1, wherein substantial direction of principal axis of the magnetic anisotropy rises by 10-80° C. from the surface of the recording medium.

4. A magnetic recording and reproducing system according to claim 1, wherein at least one material selected from Permalloy, Sendust and Fe-Si, Fe, Fe-Co, Fe-C and Co based amorphous alloys is used as the high saturation magnetic flux density material.

5. A magnetic recording and regenerating system according to claim 1, wherein at least one material selected from Mn-Zn ferrite and Ni-Zn ferrite is used as a low saturation magnetic flux density material.

6. A magnetic recording and reproducing system according to claim 1 wherein the magnetic recording medium having uniaxial oblique magnetic anisotropy is formed of at least on vapor deposited film selected from Fe, Co, Ni and alloys mainly composed of them.

7. A magnetic recording and regenerating system according to claim 1, wherein the magnetic recording medium having monodirectional oblique magnetic anisotropy is a coated type medium coated with a dispersion of magnetic fine particles comprising γ-Fe₂O₃, Fe₃O₄, Co-deposited γ-Fe₂O₃, Fe, Fe-Co alloy or barium ferrite in a binder.
